(19) United States
(12) Patent Application Publication
(10) Pub. No.: US 2023/0195135 A1
(43) Pub. Date: Jun. 22, 2023

(54) ENGAGEMENT AND DISENGAGEMENT OF UNSUPERVISED AUTONOMOUS DRIVING MODE

(71) Applicant: GM Cruise Holdings LLC, San Francisco, CA (US)

(72) Inventors: Disha Kote, San Francisco, CA (US); Rushil Goradia, SAN FRANCISCO, CA (US)

(21) Appl. No.: 17/553,402

(22) Filed: Dec. 16, 2021

(51) Int. Cl. G05D 1/02; G05D 1/00

(52) U.S. Cl. CPC G05D 1/0276; G05D 1/0011; G05D 1/0061; G05D 1/0088

(57) ABSTRACT

Disclosed are systems and techniques for managing an autonomous vehicle (AV). In some aspects, an AV may receive an engage unsupervised autonomous driving mode instruction from a remote fleet server directing the AV to engage an unsupervised autonomous driving mode. The AV may switch into the unsupervised autonomous driving mode after successful completion of one or more safety checks. In some examples, the AV may transmit a message indicating the successful completion of the one or more safety checks to the remote fleet server. The AV may receive an initiate unsupervised autonomous driving instruction from the remote fleet server directing the AV to mobilize using the unsupervised autonomous driving mode.

### FIELD OF THE DISCLOSURE

Aspects of the present disclosure generally relate to autonomous vehicles. In some implementations, examples are described for engagement and disengagement of an unsupervised autonomous driving mode for an autonomous vehicle.

### BACKGROUND

An autonomous vehicle is a motorized vehicle that can navigate without a human driver. An example autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

FIG. 1 illustrates an example environment that includes an autonomous vehicle in communication with a computing system, according certain aspects of the present technology.

FIG. 2 is a flowchart illustrating an example method for engaging an unsupervised autonomous driving mode by an autonomous vehicle, according certain aspects of the present technology.

FIG. 3 is a flowchart illustrating an example method for engaging a supervised autonomous driving mode or an unsupervised autonomous mode by an autonomous vehicle, according certain aspects of the present technology.

FIG. 4 is a flowchart illustrating an example method for engaging an unsupervised autonomous driving mode for an autonomous vehicle by a remote server, according certain aspects of the present technology.

FIG. 5 illustrates an example functional diagram for engaging an autonomous driving mode, according certain aspects of the present technology.

FIG. 6 illustrates an example functional diagram for disengaging an unsupervised autonomous driving mode, according certain aspects of the present technology.

FIG. 7 illustrates an example of a system for implementing certain aspects of the present technology.

### DETAILED DESCRIPTION

Certain aspects and embodiments of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects and embodiments described herein may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the application as set forth in the appended claims.

Autonomous vehicles can be implemented by companies to provide self-driving car services for the public, such as taxi or ride-hailing (e.g., ride-sharing) services. The self-driving car services can increase transportation options and provide a flexible and convenient way to transport users between locations. A user will typically request a ride through an application provided by the self-driving car service to use a self-driving car service. When requesting the ride, the user can designate a pick-up and drop-off location, which the self-driving car service can use to identify the route of the user and select a nearby autonomous vehicle that is available to provide the requested ride to the user.

In some cases, an autonomous vehicle can support different modes of operation with varying degrees of autonomy. For example, an autonomous vehicle can be configured to operate in a manual driving mode in which a human driver operates the autonomous vehicle in a traditional manner. An autonomous vehicle may also be configured to operate in a supervised autonomous driving mode in which a human driver may be positioned in the driver’s seat and may take control of the autonomous vehicle when a safety critical event or other concerning event occurs (e.g., the autonomous vehicle can be supervised by a local driver or technician). In some cases, an autonomous vehicle may be configured to operate in a driverless autonomous driving mode (referred to herein as an unsupervised autonomous driving mode) in which the autonomous vehicle may operate without a driver or technician providing local human supervision (e.g., the term “unsupervised” refers to the absence of local human supervision). As described further herein, operation of an autonomous vehicle in the unsupervised autonomous driving mode can be monitored or supervised by hardware and software that is configured on the autonomous vehicle (e.g., computing system, sensors, actuators, etc.) as well as a remote computing system (e.g., a remote fleet server). In some examples, an autonomous vehicle operating in an unsupervised autonomous driving mode may be configured to disregard intervention from a human that is being transported by the autonomous vehicle.

In some cases, an autonomous vehicle may need to transition between these different operating modes. For example, an autonomous vehicle engages unsupervised autonomous driving mode while in a manual driving mode. In another example, an autonomous vehicle may need to disengage an unsupervised autonomous driving mode and return to a manual driving mode.

The disclosed technologies address a need in the art for safely engaging and/or disengaging autonomous driving modes for an autonomous vehicle. In some examples, an autonomous vehicle can send a message to a remote fleet server indicating that the autonomous vehicle is available for unsupervised autonomous driving mode (e.g., the autonomous vehicle is stationary in a safe location). In some embodiments, the autonomous vehicle can receive an instruction to transition to an unsupervised autonomous mode from the remote fleet server. In some cases, the autonomous vehicle can conduct vehicle diagnostics and configure vehicle actuator systems to engage autonomously. In some aspects, the autonomous vehicle can send a message to the remote fleet server when the autonomous vehicle is configured for the unsupervised autonomous driving mode. In some cases, the autonomous vehicle can remain stationary until a second command directing the autonomous vehicle to depart or mobilize is received from the remote fleet server. In some examples, the remote fleet server may conduct additional safety checks prior to issuing the mobilization command to the autonomous vehicle.

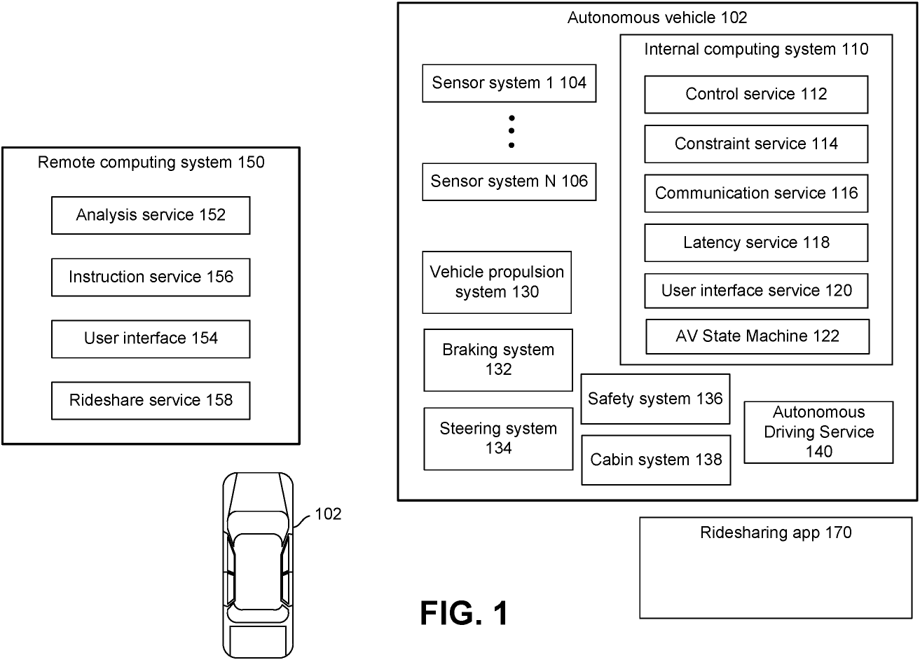

FIG. 1 illustrates environment 100 that includes an autonomous vehicle 102 in communication with a computing system 150.

The autonomous vehicle 102 can navigate about roadways without a human driver based upon sensor signals output by sensor systems 104-106 of the autonomous vehicle 102. The autonomous vehicle 102 includes a plurality of sensor systems 104-106 (a first sensor system 104 through an Nth sensor system 106). The sensor systems 104-106 are of different types and are arranged about the autonomous vehicle 102. For example, the first sensor system 104 may be a camera sensor system and the Nth sensor system 106 may be a lidar sensor system. Other exemplary sensor systems include radar sensor systems, global positioning system (GPS) sensor systems, inertial measurement units (IMU), infrared sensor systems, laser sensor systems, sonar sensor systems, and the like.

The autonomous vehicle 102 further includes several mechanical systems that are used to effectuate appropriate motion of the autonomous vehicle 102. For instance, the mechanical systems can include but are not limited to, a vehicle propulsion system 130, a braking system 132, and a steering system 134. The vehicle propulsion system 130 may include an electric motor, an internal combustion engine, or both. The braking system 132 can include an engine brake, brake pads, actuators, and/or any other suitable componentry that is configured to assist in decelerating the autonomous vehicle 102. The steering system 134 includes suitable componentry that is configured to control the direction of movement of the autonomous vehicle 102 during navigation.

The autonomous vehicle 102 further includes a safety system 136 that can include various lights and signal indicators, parking brake, airbags, etc. The autonomous vehicle 102 further includes a cabin system 138 that can include cabin temperature control systems, in-cabin entertainment systems, etc.

The autonomous vehicle 102 additionally comprises an internal computing system 110 that is in communication with the sensor systems 104-106 and the mechanical systems 130, 132, 134. The internal computing system includes at least one processor and at least one memory having computer-executable instructions that are executed by the processor. The computer-executable instructions can make up one or more services responsible for controlling the autonomous vehicle 102, communicating with remote computing system 150, receiving inputs from passengers or human co-pilots, logging metrics regarding data collected by sensor systems 104-106 and human co-pilots, etc.

The internal computing system 110 can include a control service 112 that is configured to control operation of the vehicle propulsion system 106, the braking system 108, the steering system 110, the safety system 136, and the cabin system 138. The control service 112 receives sensor signals from the sensor systems 102-104 as well communicates with other services of the internal computing system 110 to effectuate operation of the autonomous vehicle 102. In some embodiments, control service 112 may carry out operations in concert with one or more other systems of autonomous vehicle 102.

The internal computing system 110 can also include a constraint service 114 to facilitate safe propulsion of the autonomous vehicle 102. The constraint service 114 includes instructions for activating a constraint based on a rule-based restriction upon operation of the autonomous vehicle 102. For example, the constraint may be a restriction upon navigation that is activated in accordance with protocols configured to avoid occupying the same space as other objects, abide by traffic laws, circumvent avoidance areas, etc. In some embodiments, the constraint service can be part of the control service 112.

The internal computing system 110 can also include a communication service 116. The communication service can include both software and hardware elements for transmitting and receiving signals from/to the remote computing system 150. The communication service 116 is configured to transmit information wirelessly over a network, for example, through an antenna array that provides personal cellular (long-term evolution (LTE), 3G, 5G, etc.) communication.

The internal computing system 110 can also include an autonomous vehicle (AV) state machine 122. In some embodiments, the AV state machine 122 may be used to configure autonomous vehicle 102 into one or more modes of operation and/or to transition between various modes of operation. For example, the AV state machine 122 can be used to configure autonomous vehicle 102 into a supervised autonomous driving mode in which the autonomous vehicle 102 may operate autonomously with an operator (e.g., human driver) present. In some examples, the AV state machine 122 may be configured to disengage the supervised autonomous driving mode based on a local input received via a vehicle actuator from the human driver (e.g., movement of steering wheel, pressure applied to brake and/or accelerator pedal, etc.).

In another example, the AV state machine 122 can be used to configure autonomous vehicle 102 into an unsupervised autonomous driving mode in which the autonomous vehicle 102 may operate autonomously without a human driver present. In some embodiments, the AV state machine 122 may configured autonomous vehicle 102 to ignore local input received via a vehicle actuator when autonomous vehicle 102 is configured to operate in an unsupervised autonomous driving mode. In another example, the AV state machine 122 can be used to configure autonomous vehicle 102 into a manual driving mode in which the autonomous vehicle 102 may be operated by a human driver.

In some embodiments, the AV state machine 122 may be configured to send and/or receive input from remote computing system 150 (also referred to herein as a remote fleet server). For example, AV state machine 122 may receive input from remote computing system 150 indicating that autonomous vehicle 102 should be configured to operate in an unsupervised autonomous driving mode. In some cases, the AV state machine 122 may communicate with one or more other components within autonomous vehicle 102. For instance, the AV state machine 122 may communicate with control service 112 to initiate activation and/or deactivation of the vehicle propulsion system 106, the braking system 108, the steering system 110, the safety system 136, and the cabin system 138. In some embodiments, the AV state machine 122 may communicate with sensor system 104-106 to determine a status of autonomous vehicle 102 prior to engaging or disengaging a mode of operation. For example, the AV state machine 122 may communicate with sensor system 104-106 to confirm that it is safe to engage the unsupervised autonomous driving mode.

The autonomous vehicle 102 further includes an autonomous driving service 140 that can be used to control various aspects of autonomous vehicle 102. In some cases, autonomous driving service 140 may be referred to as an Autonomous Driving Integrated Module (ADIM). In some aspects, autonomous driving service 140 can include and/or operate a state machine that may be used to configure aspects of autonomous vehicle 102 into various modes of operation. For example, autonomous driving service 140 can be used to configure vehicle propulsion system 130, braking system 132, steering system 134, safety system 136, and/or cabin system 138.

In some cases, the AV state machine 122 may communicate with autonomous driving service 140. For example, the AV state machine 122 may request that autonomous driving service 140 configure autonomous vehicle 102 into the unsupervised autonomous driving mode, the supervised autonomous driving mode, and/or the manual driving mode. In some cases, autonomous driving service 140 may configure one or more aspects of autonomous vehicle 102 to operate according to mode of operation requested by AV state machine 122.

In some embodiments, one or more services of the internal computing system 110 are configured to send and receive communications to remote computing system 150 for such reasons as reporting data for training and evaluating machine learning algorithms, requesting assistance from remoting computing system or a human operator via remote computing system, software service updates, ridesharing pickup and drop off instructions etc.

The internal computing system 110 can also include a latency service 118. The latency service 118 can utilize timestamps on communications to and from the remote computing system 150 to determine if a communication has been received from the remote computing system 150 in time to be useful. For example, when a service of the internal computing system 110 requests feedback from remote computing system 150 on a time-sensitive process, the latency service 118 can determine if a response was timely received from remote computing system 150 as information can quickly become too stale to be actionable. When the latency service 118 determines that a response has not been received within a threshold, the latency service 118 can enable other systems of autonomous vehicle 102 or a passenger to make necessary decisions or to provide the needed feedback.

The internal computing system 110 can also include a user interface service 120 that can communicate with cabin system 138 in order to provide information or receive information to a human co-pilot or human passenger. In some embodiments, a human co-pilot or human passenger may be required to evaluate and override a constraint from constraint service 114, or the human co-pilot or human passenger may wish to provide an instruction to the autonomous vehicle 102 regarding destinations, requested routes, or other requested operations.

As described above, the remote computing system 150 is configured to send/receive a signal from the autonomous vehicle 102 regarding reporting data for training and evaluating machine learning algorithms, requesting assistance from remoting computing system or a human operator via the remote computing system 150, software service updates, ridesharing pickup and drop off instructions, etc.

The remote computing system 150 includes an analysis service 152 that is configured to receive data from autonomous vehicle 102 and analyze the data to train or evaluate machine learning algorithms for operating the autonomous vehicle 102. The analysis service 152 can also perform analysis pertaining to data associated with one or more errors or constraints reported by autonomous vehicle 102.

The remote computing system 150 can also include a user interface service 154 configured to present metrics, video, pictures, sounds reported from the autonomous vehicle 102 to an operator of remote computing system 150. User interface service 154 can further receive input instructions from an operator that can be sent to the autonomous vehicle 102.

The remote computing system 150 can also include an instruction service 156 for sending instructions regarding the operation of the autonomous vehicle 102. For example, in response to an output of the analysis service 152 or user interface service 154, instructions service 156 can prepare instructions to one or more services of the autonomous vehicle 102 or a co-pilot or passenger of the autonomous vehicle 102.

The remote computing system 150 can also include a rideshare service 158 configured to interact with ridesharing applications 170 operating on (potential) passenger computing devices. The rideshare service 158 can receive requests to be picked up or dropped off from passenger ridesharing app 170 and can dispatch autonomous vehicle 102 for the trip. The rideshare service 158 can also act as an intermediary between the ridesharing app 170 and the autonomous vehicle wherein a passenger might provide instructions to the autonomous vehicle to 102 go around an obstacle, change routes, honk the horn, etc.

As noted above, an autonomous vehicle (e.g., autonomous vehicle 102) may support different modes of operation. For example, an autonomous vehicle may support a manual driving mode in which the vehicle may be operated in a traditional manner by a human driver. In some cases, the autonomous vehicle may also support a supervised autonomous driving mode in which the vehicle operates autonomously with a human driver present that is able to override the autonomous operation. The autonomous vehicle may also support an unsupervised autonomous driving mode in which the vehicle operates in a fully autonomous fashion without human driver intervention. In some cases, an autonomous vehicle may need to safely transition between different these different modes of operation.

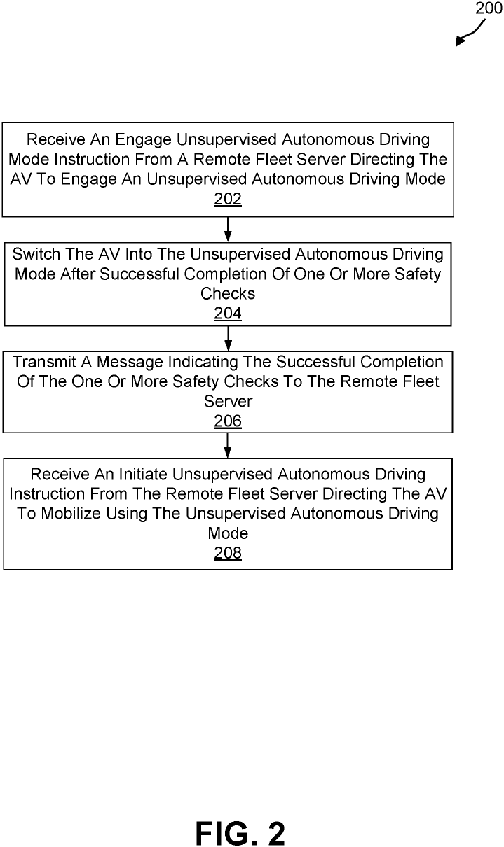

FIG. 2 illustrates an example method 200 for engaging an unsupervised autonomous driving mode. Although the example method 200 depicts a particular sequence of operations, the sequence may be altered without departing from the scope of the present disclosure. For example, some of the operations depicted may be performed in parallel or in a different sequence that does not materially affect the function of the method 200. In other examples, different components of an example device or system that implements the method 200 may perform functions at substantially the same time or in a specific sequence.

According to some embodiments, the method 200 includes receiving an engage unsupervised autonomous driving mode instruction from a remote fleet server directing the autonomous vehicle (AV) to engage an unsupervised autonomous driving mode at block 202. For example, the autonomous vehicle 102 illustrated in FIG. 1 may receive an engage unsupervised autonomous driving mode instruction from a remote fleet server (e.g., remote computing system 150) directing the AV to engage an unsupervised autonomous driving mode. In some examples, a remote operator or technician may send the engage unsupervised autonomous driving mode instruction to the AV (e.g., by operating the remote fleet server). In some aspects, the remote fleet server may direct the AV to engage an unsupervised autonomous driving mode based on a schedule. In some cases, the remote fleet server may direct the AV to engage an unsupervised autonomous driving mode based on a demand for an AV (e.g., a request from ride sharing app 170).

According to some embodiments, the method 200 can include performing one or more safety checks in response to the engage unsupervised autonomous driving mode instruction. For example, the autonomous vehicle 102 illustrated in FIG. 1 may perform one or more safety checks in response to the engage unsupervised autonomous driving mode instruction. In some embodiments, the one or more safety checks can include at least one of a vehicle mobility check, a vehicle location check, a vehicle gearshift status check, a parking brake status check, an autonomous driving system computer (ADSC) check, an operational safety check, and/or any other type of test for assessing the operational status and/or environment of the autonomous vehicle 102. In some cases, one or more safety checks may be performed by the autonomous driving service 140, the AV state machine 122, the control service, the sensor system 104-106, and/or any combination thereof.

In some aspects, the vehicle mobility check can correspond to a stationary state or a mobile state. In some embodiments, the vehicle location check can correspond to a secure launch pad associated with the AV, an address, a geolocation, etc. In some examples, the vehicle gearshift status check can correspond to a parked state (e.g., a parking brake is engaged, the AV is in park, etc.), a drive state, a reverse state, or a neutral state. In some embodiments, the parking brake status check can correspond to a parking brake engaged state or a parking brake disengaged state. In some cases, the ADSC check can correspond to a passed state or a failed state. In some cases, the operational safety check can correspond to a passed state or a failed state.

In some embodiments, at block 204 the method 200 can include switching the AV into the unsupervised autonomous driving mode after successful completion of one or more safety checks. For example, the AV state machine 122 illustrated in FIG. 1 may switch the autonomous vehicle 102 into the unsupervised autonomous driving mode after determining that the autonomous vehicle 102 is in a safe environment (e.g., stationary, parking brake engaged, gearshift status in ‘parked’ state, etc.). In some cases, a failure of the one or more safety checks may cause the AV state machine 122 to send an error message to remote computing system 150. In some embodiments, a failure of one or more safety checks can cause the autonomous vehicle 102 to transition to or remain in a manual driving mode.

In some embodiments, switching the AV into the unsupervised autonomous driving mode can include sending a communication to an autonomous driving service to enter the unsupervised autonomous driving mode. For instance, the AV state machine 122 in FIG. 1 may send a communication to an autonomous driving service 140 to enter the unsupervised autonomous mode. In response, the autonomous driving service 140 may configure one or more components of autonomous vehicle 102 to operate in the unsupervised autonomous driving mode. In some examples, the method 200 may include configuring one or more actuators on the AV to disregard local input while the AV is in the unsupervised autonomous mode. For example, the autonomous driving service 140 may configure one or more actuators (e.g., braking system 132, steering system 134, etc.) to ignore input by a human driver while autonomous vehicle 102 is in the unsupervised autonomous driving mode. In some cases, the one or more actuators can include a steering actuator, a brake actuator, a propulsion actuator, and/or a gearshift actuator. In some examples, autonomous driving service 140 may configure the steering system 134 to disregard movement of the steering wheel while the autonomous vehicle 102 is in the unsupervised autonomous driving mode. In some examples, autonomous driving service 140 may configure braking system 132 to ignore pressure applied to the brake pedal while the autonomous vehicle 102 is in the unsupervised autonomous driving mode. In some examples, autonomous driving service 140 may configure vehicle propulsion system 130 to ignore an input received via a propulsion actuator (e.g., via an accelerator, throttle, etc.) while the autonomous vehicle 102 is in the unsupervised autonomous driving mode.

In some embodiments, at block 206 the method 200 includes transmitting a message indicating the successful completion of the one or more safety checks to the remote fleet server. For example, the AV state machine 122 may send a message to remote computing system 150 indicating that the one or more safety checks have completed successfully and that autonomous vehicle 102 is ready to engage the unsupervised autonomous driving mode.

According to some embodiments, at block 208 the method 200 includes receiving an initiate unsupervised autonomous driving instruction from the remote fleet server directing the AV to mobilize using the unsupervised autonomous driving mode. For example, the AV state machine 122 illustrated in FIG. 1 may receive an initiate unsupervised autonomous driving instruction from the remote computing system 150 directing the autonomous vehicle 102 to mobilize using the unsupervised autonomous driving mode. In some embodiments, the initiate unsupervised autonomous driving mode instruction can direct the autonomous vehicle 102 to a destination. In some aspects, a remote operator can cause the remote fleet server to send the initiate unsupervised autonomous driving instruction. In some examples, the remote fleet server can send the initiate unsupervised autonomous driving instruction (e.g., without intervention by a remote operator) based on data received from the AV. For example, the remote fleet server can monitor the environment of the AV using sensor system 104-106. In some examples, the remote fleet server can monitor the environment of the AV using external sensors (e.g., cameras installed in a parking garage). In some aspects, the remote fleet server can monitor the environment for proximity of other AVs. In some cases, the remote fleet server can send the initiate unsupervised autonomous driving mode instruction when no other AVs are being launched within a proximity (e.g., 200 feet) of the AV.

In some embodiments, the method 200 can include performing one or more safety checks in response to the initiate unsupervised autonomous driving mode instruction received from the remote fleet server. For instance, the autonomous vehicle 102 illustrated in FIG. 1 may perform one or more safety checks in response to the initiate unsupervised autonomous driving mode instruction received from the remote computing system 150. In some aspects, the one or more safety checks can be performed as a second layer of safety checks prior to mobilizing the AV using the unsupervised autonomous driving mode. In some embodiments, the one or more safety checks can include at least one of a vehicle mobility check, a vehicle location check, a vehicle gearshift status check, a parking brake status check, an autonomous driving system computer (ADSC) check, an operational safety check, and/or any other type of test for assessing the operational status and/or environment of the autonomous vehicle 102. In some cases, one or more safety checks may be performed by the autonomous driving service 140, the AV state machine 122, the control service, the sensor system 104-106, and/or any combination thereof.

According to some embodiments, the method 200 can include mobilizing the AV using the unsupervised autonomous driving mode in response to the initiate unsupervised autonomous driving instruction. For example, the AV state machine 122 illustrated in FIG. 1 may mobilize the autonomous vehicle 102 using the unsupervised autonomous driving mode in response to the initiate unsupervised autonomous driving instruction.

In some aspects, the method 200 can include receiving a disengage unsupervised autonomous driving mode instruction from the remote fleet server directing the AV to disengage the unsupervised autonomous mode. For example, the AV state machine 122 illustrated in FIG. 1 may receive a disengage unsupervised autonomous driving mode instruction from the remote computing system 150 directing the autonomous vehicle 102 to disengage the unsupervised autonomous mode.

According to some embodiments, the method 200 includes initiating a safe stop of the AV in response to the disengage unsupervised autonomous driving mode instruction. For example, the AV state machine 122 illustrated in FIG. 1 may initiate a safe stop of the AV in response to the disengage unsupervised autonomous driving mode instruction. In some examples, the AV state machine 122 may send a message to the autonomous driving service 140 and/or the control service 112 to initiate a safe stop of autonomous vehicle 102.

According to some embodiments, the method includes receiving a stop request message from a passenger in the AV while the AV is in the unsupervised autonomous driving mode. For example, the internal computing system 110 may receive a stop request message from a passenger in the AV while the AV is in the unsupervised autonomous driving mode. In some embodiments, the stop request message is received from a ride sharing application (e.g., ride sharing app 170) associated with the autonomous vehicle 102. In some embodiments, the stop request message is received from a stop button inside of the AV. For example, the stop request message may be received via user interface service 120. According to some embodiments, the method includes initiating a safe stop of the AV in response to the stop request message without transferring control of the AV to the passenger. For example, the AV state machine 122 illustrated in FIG. 1 may initiate a safe stop of the AV in response to the stop request message without transferring control of the autonomous vehicle 102 to the passenger.

In some embodiments, the method 200 may include detecting a local input on at least one of the one or more actuators while the AV is in the unsupervised autonomous driving mode and initiating a safe stop of the AV in response to the local input without transferring control of the AV to a vehicle occupant that may have initiated the local input. As noted above, in some aspects, the autonomous driving service 140 may configure one or more actuators (e.g., braking system 132, steering system 134, etc.) to ignore local input (e.g., input by a human passenger) while the autonomous vehicle 102 is in the unsupervised autonomous driving mode. In some cases, the autonomous driving service 140 and/or the AV state machine 122 may detect a local input on at least one of the one or more actuators (e.g., via vehicle propulsion system 130, braking system 132, and/or steering system 134) while the AV is in the unsupervised autonomous mode. In some embodiments, the AV state machine 122 can initiate a safe stop of autonomous vehicle 102 in response to the local input without transferring control of the AV to a human driver that may have attempted to take control of the autonomous vehicle 102 while in the unsupervised autonomous driving mode. In some cases, the local input can be detected using a torque sensor and/or a position sensor that is associated with the one or more actuators.

According to some embodiments, the method includes transitioning the AV from the unsupervised autonomous mode to a supervised autonomous mode or a manual driving mode. For example, the AV state machine 122 illustrated in FIG. 1 may transition the autonomous vehicle 102 from the unsupervised autonomous driving mode to a supervised autonomous driving mode or a manual driving mode.

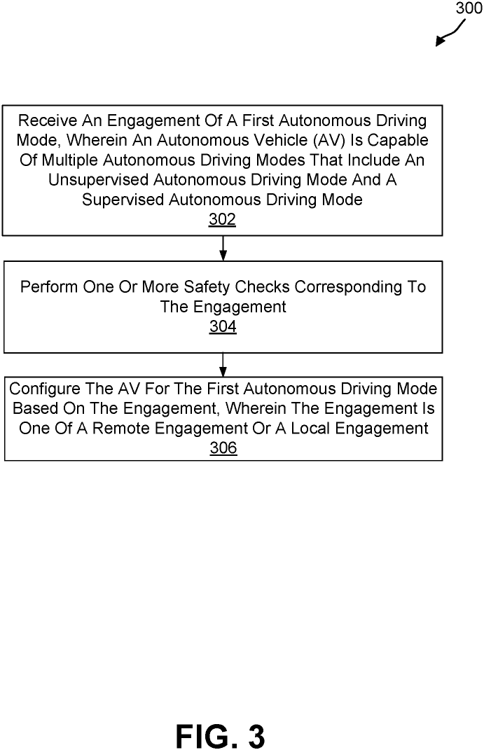

FIG. 3 illustrates an example method 300 for engaging an unsupervised autonomous driving mode. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to some embodiments, at block 302 the method 300 includes receiving an engagement of a first autonomous driving mode, wherein an autonomous vehicle is capable of multiple autonomous driving modes that include an unsupervised autonomous driving mode and a supervised autonomous driving mode. For example, the internal computing system 110 illustrated in FIG. 1 may receive an engagement of a first autonomous driving mode wherein the autonomous vehicle 102 is capable of multiple autonomous driving modes that include an unsupervised autonomous driving mode and a supervised autonomous driving mode. In some embodiments, the engagement can correspond to a local engagement received via an interface (e.g., user interface service 120) within the autonomous vehicle 102. For example, a local operator or technician may engage a supervised autonomous driving mode using user interface service 120. In some examples, the engagement can correspond to a remote engagement (e.g., from remote computing system 150) received over a wireless network interface (e.g., via communication service 116) of the autonomous vehicle 102. For instance, a remote operator or technician may send the engage unsupervised autonomous driving mode instruction to the AV (e.g., by operating the remote fleet server). In some aspects, the remote fleet server may direct the AV to engage an unsupervised autonomous driving mode without direct intervention by a remote operator (e.g., based on a schedule, AV demand, location, etc.).

In some examples, the supervised driving mode for autonomous vehicle 102 may only be engaged using a local engagement. For example, the autonomous vehicle 102 may be configured to require the presence of a local operator or technician to engage the supervised driving mode. In some aspects, the unsupervised driving mode for autonomous vehicle 102 may only be engaged using a remote fleet server. For example, the autonomous vehicle 102 may be configured to require an instruction from remote computing system 150 to engage the supervised driving mode. In some cases, access to remote computing system 150 may be restricted to trained and/or authorized operators that may cause remote computing system 150 to engage autonomous vehicle 102 in an unsupervised driving mode.

According to some embodiments, at block 304 the method 300 includes performing one or more safety checks corresponding to the engagement. For example, the autonomous vehicle 102 illustrated in FIG. 1 may perform one or more safety checks corresponding to the engagement. In some embodiments, the one or more safety checks corresponding to the local engagement are a subset of the one or more safety checks corresponding to the remote engagement. For example, the local engagement may correspond to a supervised autonomous driving mode in which a local operator (e.g., human driver) is present and may supervise autonomous vehicle 102 (e.g., the local operator may be seated in a driver seat of the vehicle and will selectively take control of the vehicle via a set of input devices (e.g., a steering wheel, an accelerator pedal, a brake pedal, etc.) upon observing the vehicle potentially approaching a safety issue/event to avoid the safety issue/event). In another example, the remote engagement may correspond to an unsupervised autonomous driving mode in which there is no human supervision of autonomous vehicle 102. In some cases, a remote engagement may correspond to a greater number of diagnostic and/or safety checks than a local engagement. In some embodiments, the one or more safety checks may include a vehicle mobility check, a vehicle location check, a vehicle gearshift status check, a parking brake status check, an autonomous driving system computer (ADSC) check, an operational safety check, and/or any other type of test for assessing operational status and/or environment of the autonomous vehicle 102. In some examples, an operational safety check may include an assessment of the surrounding of autonomous vehicle 102 using sensor system 104-106.

According to some embodiments, at block 306 the method 300 includes configuring the AV for the first autonomous driving mode based on the engagement, wherein the engagement is one of a remote engagement or a local engagement. As noted above, a remote engagement may be received from remote computing system 150 and may correspond to an unsupervised autonomous driving mode. In some examples, a local engagement may be received by user interface service 120 of autonomous vehicle 102 and may correspond to a supervised autonomous driving mode.

According to some embodiments, the method 300 includes configuring one or more actuators on the AV to disregard local input when the first autonomous driving mode is the unsupervised autonomous driving mode. For example, the autonomous driving service 140 illustrated in FIG. 1 may configure one or more actuators on the autonomous vehicle 102 to disregard local input when the mode of operation is the unsupervised autonomous driving mode. For instance, the autonomous driving service 140 may receive an input from AV state machine 122 directing the autonomous driving service 140 to configure vehicle propulsion system 130, braking system 132, and/or steering system 134 to disregard local input while autonomous vehicle 102 is in an unsupervised autonomous driving mode.

In some aspects, the method 300 can include detecting the local input on at least one of the one or more actuators while the AV is in the unsupervised autonomous driving mode and initiating a safe stop of the AV in response to the local input without transferring control of the AV to a vehicle occupant that may have initiated the local input. For example, the autonomous driving service 140 and/or the AV state machine 122 may detect a local input on at least one of the one or more actuators (e.g., via vehicle propulsion system 130, braking system 132, and/or steering system 134) while the AV is in the unsupervised autonomous mode. In some embodiments, the AV state machine 122 can initiate a safe stop of autonomous vehicle 102 in response to the local input without transfer control of the AV to a human driver that may have attempted to take control of the autonomous vehicle 102 while in the unsupervised autonomous driving mode. In some cases, the local input can be detected using a torque sensor and/or a position sensor that is associated with the one or more actuators.

In some examples, the method 300 may include configuring one or more actuators on the AV to accept local input when the first autonomous driving mode is the supervised autonomous driving mode. In some embodiments, the one or more actuators include at least one of a steering actuator, a brake actuator, a propulsion actuator, and a gearshift actuator. For instance, the autonomous driving service 140 illustrated in FIG. 1 may configure one or more actuators on the autonomous vehicle 102 to accept local input when the mode of operation is the supervised autonomous driving mode. For instance, the autonomous driving service 140 may receive an input from AV state machine 122 directing the autonomous driving service 140 to configure vehicle propulsion system 130, braking system 132, and/or steering system 134 to accept local input while autonomous vehicle 102 is in an supervised autonomous driving mode. In some cases, a human driver may take control of autonomous vehicle 102 (e.g., using a local input) while it is in a supervised autonomous driving mode. In some examples, the method 300 includes transitioning the AV from the supervised autonomous driving mode to a manual driving mode in response to the local input. For example, AV state machine 122 may cause autonomous vehicle 102 to transition from a supervised autonomous driving mode to a manual driving mode in response to a local input (e.g., movement of the steering wheel, pressure on propulsion actuator, pressure on brake pedal, etc.). In some embodiments, the transitioning from the supervised autonomous driving mode to the manual mode in response to detecting the local input occurs substantially immediately upon the detecting the local input.

According to some embodiments, the method 300 includes sending a communication indicating that the AV is in a location and a mobility status that is acceptable to be disengaged from unsupervised autonomous driving mode. For example, the internal computing system 110 illustrated in FIG. 1 may send a communication to remote computing system 150 indicating that the autonomous vehicle 102 is in a location and a mobility status that is acceptable to be disengaged from unsupervised autonomous driving mode. In some examples, the location may correspond to parking space and the mobility status may correspond to the autonomous vehicle being in park with a parking brake engaged.

According to some embodiments, the method 300 includes receiving a command over a wireless network to disengage from the unsupervised autonomous driving mode. For example, the remote computing system 150 illustrated in FIG. 1 may send a command over a wireless network to autonomous vehicle 102 directing it to disengage from the unsupervised autonomous driving mode. In response, the AV state machine 122 in autonomous vehicle 102 may send a command to autonomous driving service 140 and/or control service 112 to configure autonomous vehicle 102 to disengage from the unsupervised autonomous driving mode. In some aspects, a remote operator can cause the remote computing system 150 to send the command to disengage from the unsupervised autonomous driving mode. In some examples, the remote computing system 150 can send the command to disengage from the unsupervised autonomous driving mode based on data received from the AV. For example, the remote computing system 150 can monitor the environment of the AV using sensor system 104-106.

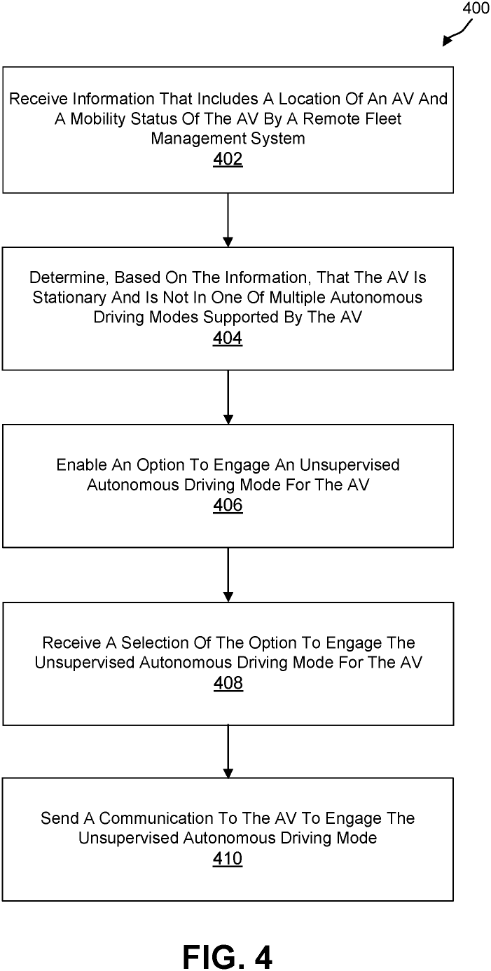

FIG. 4 illustrates an example method 400 for engaging an unsupervised autonomous driving mode by a remote computing system. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some embodiments, at block 402 the method 400 includes receiving information that includes a location of an autonomous vehicle (AV) and a mobility status of the AV by a remote fleet management system. For example, the remote computing system 150 illustrated in FIG. 1 may receive information including a location of autonomous vehicle 102 and mobility information of autonomous vehicle 102.

According to some embodiments, at block 404 the method 400 includes determining, based on the information, that the AV is stationary and is not in one of multiple autonomous driving modes supported by the AV. For example, the remote computing system 150 illustrated in FIG. 1 may determine that the autonomous vehicle 102 is stationary and is not already in one of multiple autonomous driving modes supported by the autonomous vehicle 102.

According to some embodiments, at block 406 the method 400 includes enabling an option to engage an unsupervised autonomous driving mode. For example, the remote computing system 150 illustrated in FIG. 1 may enable an option to engage an unsupervised autonomous driving mode for autonomous vehicle 102.

According to some embodiments, at block 408 the method 400 includes receiving a selection of the option to engage the unsupervised autonomous driving mode. For example, the remote computing system 150 illustrated in FIG. 1 may receive a selection of the option to engage the unsupervised autonomous driving mode. In some aspects, access to the remote fleet management system may be restricted to authorized and or trained operators. For example, remote computing system 150 may require a local operator to provide credentials (e.g., username, password, biometric scan, and/or any other suitable authentication technique) prior to processing selection of the option to engage the unsupervised autonomous driving mode.

According to some embodiments, at block 410 the method 400 includes sending a communication to the AV to engage the unsupervised autonomous driving mode. For example, the remote computing system 150 illustrated in FIG. 1 may send a communication to the autonomous vehicle 102 to engage the unsupervised autonomous driving mode. In some aspects, the AV state machine 122 in autonomous vehicle 102 may process the input from remote computing system 150 and initiate the transition to the unsupervised autonomous driving mode by sending a communication to the control service 112 and/or the autonomous driving service 140.

According to some embodiments, the method 400 includes receiving a communication from the AV that it has engaged unsupervised autonomous driving mode. For example, the remote computing system 150 illustrated in FIG. 1 may receive a communication from the autonomous vehicle 102 that it has engaged unsupervised autonomous driving mode.

According to some embodiments, the method 400 includes determining that the AV is stationary and that vehicle sensors indicate that it is safe for the AV to initiate unsupervised autonomous driving. For example, the remote computing system 150 illustrated in FIG. 1 may determine that the autonomous vehicle 102 is stationary and that vehicle sensors indicate that it is safe for the autonomous vehicle 102 to initiate unsupervised autonomous driving.

According to some embodiments, the method 400 includes enabling an option to instruct the AV to initiate the unsupervised autonomous driving. For example, the remote computing system 150 illustrated in FIG. 1 may enable an option to instruct the autonomous vehicle 102 to initiate the unsupervised autonomous driving.

According to some embodiments, the method 400 includes sending a communication to the AV to initiate the unsupervised autonomous driving. For example, the remote computing system 150 illustrated in FIG. 1 may send a communication to the autonomous vehicle 102 to initiate the unsupervised autonomous driving. In some aspects, the communication to the AV to initiate the unsupervised autonomous driving can include a destination.

According to some embodiments, the method 400 includes receiving, by the remote fleet management system, an indication that the AV is in a parked state while the AV is in the unsupervised autonomous driving mode. For example, the remote computing system 150 illustrated in FIG. 1 may receive an indication that autonomous vehicle 102 is in a parked state while autonomous vehicle 102 is in the unsupervised autonomous driving mode.

According to some embodiments, the method 400 includes enabling an option to instruct the AV to disengage from the unsupervised autonomous driving mode. For example, the remote computing system 150 illustrated in FIG. 1 may enable an option to instruct the autonomous vehicle 102 to disengage from the unsupervised autonomous driving mode.

According to some embodiments, the method 400 includes sending a communication to the AV to disengage from the unsupervised autonomous driving mode. For example, the remote computing system 150 may send a communication to the autonomous vehicle 102 to disengage from the unsupervised autonomous driving mode.

In some aspects, the operations discussed with respect to example method 400 may be implemented to control or configure a group or fleet of autonomous vehicles. For example, remote computing system 150 may be configured to communicate with a group of autonomous vehicles such as autonomous vehicle 102. In some embodiments, remote computing system 150 may perform one or more of the operations discussed with respect to method 400 to simultaneously configure multiple autonomous vehicles to implement an unsupervised autonomous driving mode.

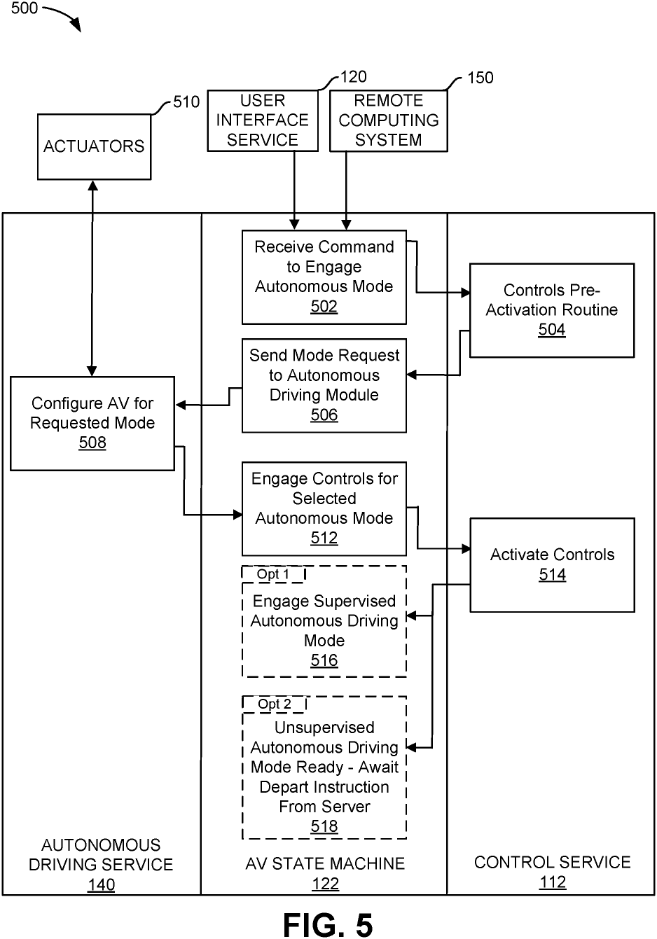

FIG. 5 illustrates a functional sequence diagram for engaging an autonomous driving mode. In some embodiments, the sequence 500 may be performed by an autonomous vehicle (e.g., autonomous vehicle 102) including a driving service 140, an AV state machine 122, and a control service 112 (e.g., as illustrated in FIG. 1). At block 502, the AV state machine 122 can receive a command to engage an autonomous driving mode. In some embodiments, the command can be a local command received from a user interface service 120. In some aspects, the command can be a remote command received from a remote computing system 150 (e.g., a remote fleet server). In some embodiments, the command received from the user interface service 120 can correspond to a command to engage autonomous vehicle 102 in a supervised autonomous driving mode. In some aspects, the command received from the remote computing system 150 can correspond to a command to engage autonomous vehicle 102 in an unsupervised autonomous driving mode.

At block 504, control service 112 can receive an instruction from the AV state machine 122 to perform a controls pre-activation routine. In some embodiments, the control service’s pre-activation routine can include initialization of the vehicle propulsion system 106, the braking system 108, the steering system 110, the safety system 136, and the cabin system 138. Upon completion of the control service pre-activation routine, at block 506 the AV state machine 122 can send an instruction to autonomous driving service 140 to configure the requested autonomous driving mode. For example, AV state machine 122 can instruct autonomous driving service 140 to configure autonomous vehicle 102 for a supervised autonomous driving mode or an unsupervised autonomous driving mode.

At block 508, autonomous driving service 140 can configure autonomous vehicle 102 for the selected autonomous driving mode of operation. In some aspects, autonomous driving service 140 may perform one or more diagnostic checks associated with the selected autonomous driving mode of operation. In some examples, autonomous driving service 140 can configure autonomous vehicle 102 for an unsupervised autonomous driving mode by configuring one or more actuators 510 to ignore or disregard any local input. In some embodiments, the actuators 510 can include vehicle propulsion system 130, braking system 132, and/or steering system 134. For instance, autonomous driving service 140 can configure actuators 510 (e.g., a steering actuator, a brake actuator, a propulsion actuator, and/or a gearshift actuator) to disregard inputs received from a passenger while the autonomous vehicle 102 is in an unsupervised autonomous driving mode.

In another illustrative example, autonomous driving service 140 can configure autonomous vehicle 102 for a supervised autonomous driving mode by configuring one or more actuators 510 to detect and respond to any local input. For example, autonomous driving service 140 can configure actuators 510 (e.g., a steering actuator, a brake actuator, a propulsion actuator, and/or a gearshift actuator) to detect input received from a human driver while the autonomous vehicle 102 is in a supervised autonomous driving mode. In some embodiments, local input during a supervised autonomous driving mode may cause autonomous vehicle 102 to shift into a manual driving mode.

At block 512, the AV state machine 122 can receive an acknowledgment from autonomous driving service 140 indicating that autonomous vehicle 102 is ready for the selected autonomous driving mode. In some embodiments, the AV state machine 122 can send an instruction to control service 112 to activate controls at block 514. In some aspects, the control service 112 may activate controls by enabling the vehicle propulsion system 106, the braking system 108, the steering system 110, the safety system 136, and the cabin system 138 for the selected autonomous driving mode.

At block 516, the AV state machine 122 may optionally receive a signal from the control service 112 indicating that the supervised autonomous driving mode has been engaged. In some embodiments, autonomous vehicle 102 may then mobilize using the supervised autonomous driving mode. Alternatively, at block 518 the AV state machine 122 may receive a signal from the control service 112 indicating that the unsupervised autonomous driving mode has been engaged. In some embodiments, the AV state machine 122 may then send a signal to remote computing system 150 indicating that autonomous vehicle 102 is ready to engage the unsupervised autonomous driving mode. In some aspects, the AV state machine 122 may cause the autonomous vehicle 102 to remain stationary until it receives a depart command from remote computing system 150.

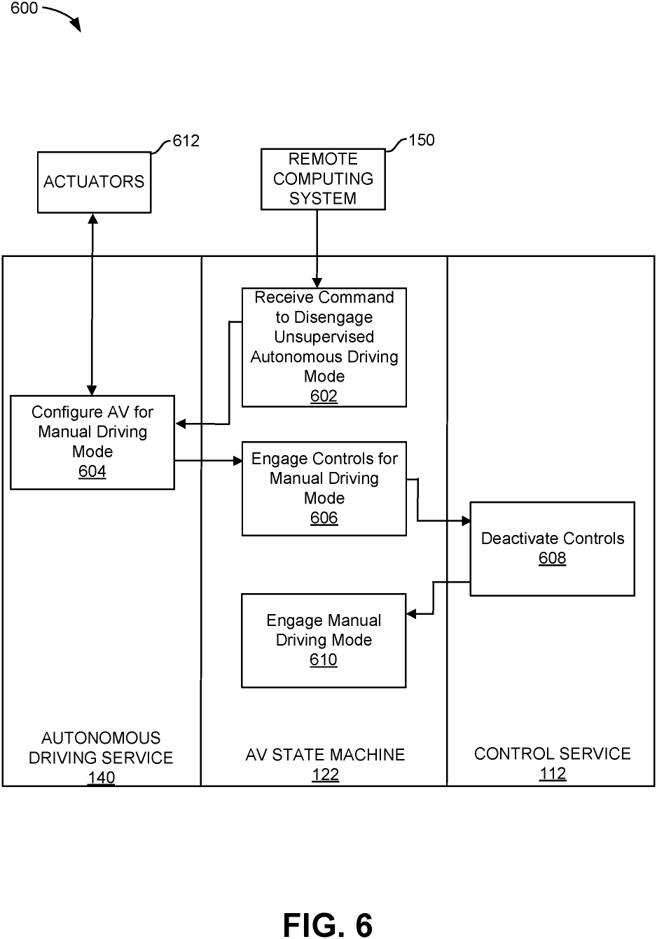

FIG. 6 illustrates a functional sequence diagram for disengaging from an unsupervised autonomous driving mode. In some embodiments, the sequence 600 may be performed by an autonomous vehicle (e.g., autonomous vehicle 102) including a driving service 140, an AV state machine 122, and a control service 112 (e.g., as illustrated in FIG. 1). At block 602, the AV state machine 122 can receive a command to disengage an unsupervised autonomous driving mode from remote computing system 150. In some embodiments, the AV state machine 122 can send information to remote computing system 150 indicating that the autonomous vehicle 102 is ready to disengage from an unsupervised autonomous driving mode. For example, the AV state machine 122 may send information to remote computing system 150 indicating that autonomous vehicle 102 is stationary in a parked state with a parking brake engaged. In some examples, if the autonomous vehicle 102 is not ready to disengage from an unsupervised autonomous driving mode, the AV state machine 122 may send a response to remote computing system 150 indicating that autonomous vehicle 102 will initiate a safe stop prior to disengaging the unsupervised autonomous driving mode.

At block 604, autonomous driving service 140 can receive a message from the AV state machine 122 to disengage unsupervised autonomous driving mode and configure the autonomous vehicle 102 for manual driving mode. In some embodiments, autonomous driving service 140 may communicate with actuators 612 (e.g., vehicle propulsion system 130, braking system 132, and/or steering system 134) to disengage unsupervised autonomous driving mode. For example, autonomous driving service 140 can configure a steering actuator, a braking actuator, and/or a propulsion actuator to receive and process input from a human driver.

At block 606, the AV state machine 122 may receive confirmation from autonomous driving service 140 that the autonomous vehicle has been configured for manual driving mode. In some embodiments, the AV state machine 122 can send an instruction to control service 112 to deactivate autonomous controls. In some aspects, control service 112 may disable control of the vehicle propulsion system 106, the braking system 108, the steering system 110, the safety system 136, and the cabin system 138. In some aspects, control service 112 can send a response to the AV state machine 122 indicating that controls have been deactivated. At block 610, the AV state machine 122 may engage autonomous vehicle 102 in a manual driving mode.

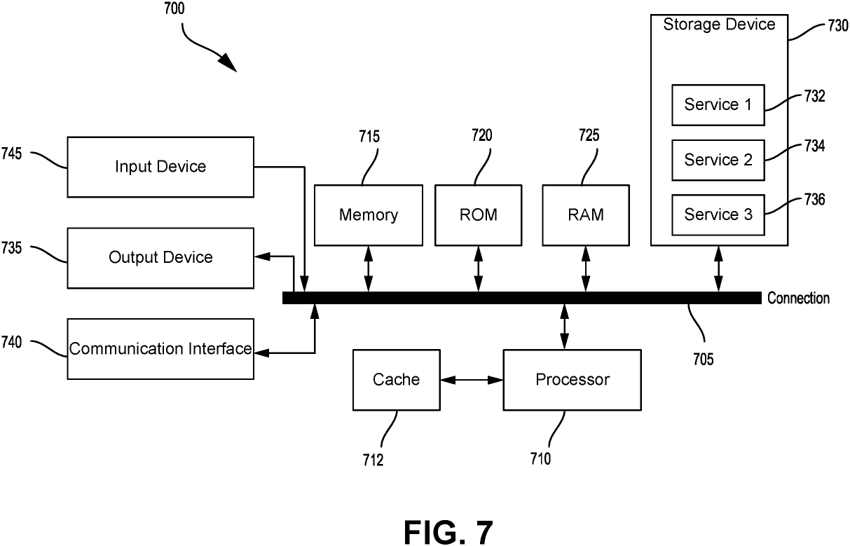

FIG. 7 shows an example of computing system 700, which can be for example any computing device making up autonomous vehicle 102 or remote computing system 150, or any component of autonomous vehicle 102 or remote computing system 150 in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including system memory 715, such as read-only memory (ROM) 720 and random access memory (RAM) 725 to processor 710. Computing system 700 can include a cache of high-speed memory 712 connected directly with, in close proximity to, or integrated as part of processor 710.

Processor 710 can include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. There is no restriction on operating on any particular hardware arrangement, and therefore the basic features here may easily be substituted for improved hardware or firmware arrangements as they are developed.

Storage device 730 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Some examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” a set indicates that one member of the set or multiple members of the set satisfy the claim. For example, claim language reciting “at least one of A and B” means A, B, or A and B.

What is claimed is:

1. A method for engaging an unsupervised autonomous driving mode in an autonomous vehicle (AV) comprising:
receiving an engage unsupervised autonomous driving mode instruction from a remote fleet server directing the AV to engage an unsupervised autonomous driving mode;
switching the AV into the unsupervised autonomous driving mode after successful completion of one or more safety checks;
transmitting a message indicating the successful completion of the one or more safety checks to the remote fleet server; and
receiving an initiate unsupervised autonomous driving instruction from the remote fleet server directing the AV to mobilize using the unsupervised autonomous driving mode.

2. The method of claim 1, further comprising:
mobilizing the AV using the unsupervised autonomous driving mode in response to the initiate unsupervised autonomous driving instruction.

3. The method of claim 1, further comprising:
performing the one or more safety checks in response to the engage unsupervised autonomous driving mode instruction.

4. The method of claim 1, wherein the switching the AV into the unsupervised autonomous driving mode further comprises:
sending a communication to an autonomous driving service to enter the unsupervised autonomous driving mode; and
configuring, by the autonomous driving service, one or more actuators on the AV to disregard local input while the AV is in the unsupervised autonomous driving mode.

5. The method of claim 4, further comprising:
detecting the local input on at least one of the one or more actuators while the AV is in the unsupervised autonomous driving mode; and
initiating a safe stop of the AV in response to the local input without transferring control of the AV to a vehicle occupant that may have initiated the local input.

6. The method of claim 5, wherein the local input is detected using at least one of a torque sensor and a position sensor that is associated with the one or more actuators.

7. The method of claim 1, further comprising:
receiving a stop request message from a passenger in the AV while the AV is in the unsupervised autonomous driving mode; and
initiating a safe stop of the AV in response to the stop request message without transferring control of the AV to the passenger.

8. The method of claim 1, further comprising:
receiving a disengage unsupervised autonomous driving mode instruction from the remote fleet server directing the AV to disengage the unsupervised autonomous driving mode;
initiating a safe stop of the AV in response to the disengage unsupervised autonomous driving mode instruction; and
transitioning the AV from the unsupervised autonomous driving mode to a supervised autonomous driving mode or a manual driving mode.

9. An autonomous vehicle (AV) comprising:
at least one memory; and
at least one processor coupled to the at least one memory, wherein the at least one processor is configured to:
receive an engagement of a first autonomous driving mode, wherein the AV is capable of multiple autonomous driving modes that include an unsupervised autonomous driving mode and a supervised autonomous driving mode;
perform one or more safety checks corresponding to the engagement; and
configure the AV for the first autonomous driving mode based on the engagement, wherein the engagement is one of a remote engagement or a local engagement.

10. The AV of claim 9, wherein the at least one processor is further configured to:
configure one or more actuators on the AV to disregard local input when the first autonomous driving mode is the unsupervised autonomous driving mode.

11. The AV of claim 10, wherein the at least one processor is further configured to:
detect the local input on at least one of the one or more actuators while the AV is in the unsupervised autonomous driving mode; and
initiate a safe stop of the AV in response to the local input without transferring control of the AV to a vehicle occupant that may have initiated the local input.

12. The AV of claim 9, wherein the at least one processor is further configured to:
configure one or more actuators on the AV to accept local input when the first autonomous driving mode is the supervised autonomous driving mode.

13. The AV of claim 12, wherein the at least one processor is further configured to:
transition the AV from the supervised autonomous driving mode to a manual driving mode in response to detecting the local input.

14. The AV of claim 9, wherein the at least one processor is further configured to:
send a communication indicating that the AV is in a location and a mobility status that is acceptable to be disengaged from the unsupervised autonomous driving mode;
receive a command over a wireless network to disengage from the unsupervised autonomous driving mode; and
return the AV to a manual driving mode.

15. The AV of claim 9, wherein the at least one processor is further configured to:
receive a stop request message from a passenger in the AV while the AV is in the unsupervised autonomous driving mode; and
initiate a safe stop of the AV in response to the stop request message without transferring control of the AV to the passenger.

16. The AV of claim 9, wherein the one or more safety checks corresponding to the local engagement are a subset of the one or more safety checks corresponding to the remote engagement.

17. A non-transitory computer-readable storage medium having stored thereon instructions which, when executed by one or more processors, cause the one or more processors to:
receive information that includes a location of an AV and a mobility status of the AV by a remote fleet management system;
determine, based on the information, that the AV is stationary and is not in one of multiple autonomous driving modes supported by the AV;
enable an option to engage an unsupervised autonomous driving mode for the AV;
receive a selection of the option to engage the unsupervised autonomous driving mode for the AV; and
send a communication to the AV to engage the unsupervised autonomous driving mode.

18. The non-transitory computer-readable storage medium of claim 17, comprising instructions which, when executed by one or more processors, cause the one or more processors to:
receive a communication from the AV indicating engagement of the unsupervised autonomous driving mode;
determine that the AV is stationary and that vehicle sensors indicate that it is safe for the AV to initiate unsupervised autonomous driving;
enable an option to instruct the AV to initiate the unsupervised autonomous driving; and
send a communication to the AV to initiate the unsupervised autonomous driving.

19. The non-transitory computer-readable storage medium of claim 18, wherein the communication to the AV to initiate the unsupervised autonomous driving includes a destination.

20. The non-transitory computer-readable storage medium of claim 17, comprising instructions which, when executed by one or more processors, cause the one or more processors to:
receive, by the remote fleet management system, an indication that the AV is in a parked state while the AV is in the unsupervised autonomous driving mode;
enable an option to instruct the AV to disengage from the unsupervised autonomous driving mode; and
send a communication to the AV to disengage from the unsupervised autonomous driving mode.
